(19) United States
(12) Patent Application Publication
(10) Pub. No.: US 2009/0045255 A1
(43) Pub. Date: Feb. 19, 2009

(54) GAMING SYSTEM CARD READER/WRITER/DISPENSER HAVING PROVISION FOR CARD RECYCLING

(76) Inventor: W. Randall Adams, Las Vegas, NV (US)

Correspondence Address: JAMES D. ERICKSON;c/o JCM AMERICAN, 925 PILOT ROAD, LAS VEGAS, NV, 89119, US

(21) Appl. No.: 11/577,161

(22) PCT Filed: Oct. 12, 2005
(86) PCT No.: PCT/US05/36501

§ 371 Date: Apr. 12, 2007

Related U.S. Application Data
(60) Provisional application No. 60/617,685, filed on Oct. 12, 2004.

(51) Int. Cl. G06F 17/00; G06K 5/00

(52) U.S. Cl. 235/381; 235/375

(57) ABSTRACT

An apparatus for processing cards bearing machine readable data is provided that includes a housing, a hopper in the housing for storing and dispensing cards capable of bearing machine readable data, mounted in the housing are also a card input receiver for receiving a previously used card in the apparatus, a card reader for reading data on the previously used card, and a card writer for writing data onto the previously used card or a card from the hopper. The apparatus further includes mounted in the housing a card dispenser for dispensing at least one of the previously used card or a card from the hopper to a user, a card recycler for erasing a previously used card for reuse, a card pathway from the card recycler to the hopper, and a plurality of additional card pathways to provide for movement of the card being processed among the card input receiver, the card reader, the card writer, the card dispenser, and the card recycler.

This application claims priority from copending U.S. provisional application No. 60/617,685 filed Oct. 12, 2004.

### BACKGROUND OF THE INVENTION

The present invention is generally directed to apparatus that read, write and dispense cards. More particularly, the present invention is directed to apparatus that read, write and dispense cards for gaming machines.

Apparatus that read, write and dispense cards are known. For example, U.S. Pat. No. 5,814,96 (Benson et al.) is directed to a card issuing and processing system embodied in a terminal. The card has both human-readable (e.g., visual indicia) and machine-readable (e.g., magnetic stripes or integrated circuit) data. The machine has an input hopper for storing and dispensing new cards and various processing stations, including a cleaning station, a magnetic write station, an IC=station, a magnetic read station and a print station. The cleaning station cleans the surface of the card in preparation for a subsequent operation within the machine. The IC station accomplishes data transfer for cards having a chip. The print station applies visual data, including graphics, text, bar-codes, and the like. Input/output devices, including a security code or PIN (personal identification number) device, can be used.

U.S. Pat. No. 5,753,897 (Kasper) is directed to an apparatus for dispensing articles such as tickets and cards that have an integrated circuit chip. The apparatus includes a cabinet and article dispensing assemblies inside the cabinet. Each article dispensing assembly includes a base and a frame for enclosing the articles to be dispensed in a stack. The apparatus may include a read/write head assembly for reading information from the chip at the bottom of the stack and/or writing information onto the chip on the card at the bottom of the stack.

While various card readers, writers, and dispenser apparatus are known, none is known that provides for recycling of a used card for re-use by a new user. Additionally, none is known that provides for the ability to capture and store cards based on particular parameters. For example, duplicate cards or cards incapable of being read may be captured.

All references cited herein are incorporated herein by reference in their entireties.

### BRIEF SUMMARY OF THE INVENTION

An apparatus for processing cards bearing machine readable data is provided that includes a housing, a hopper in the housing for storing and dispensing cards capable of bearing machine readable data, a card input receiver mounted in the housing for receiving a previously used card in the apparatus, a card reader for reading data on the previously used card, mounted in the housing, and a card writer for writing data onto the previously used card or a card from the hopper that is also mounted in the housing. The apparatus further includes a card dispenser mounted in the housing for dispensing at least one of the previously used card or the card from the hopper out of the housing to a user, a card recycler for erasing a previously used card for reuse, a card pathway from the card recycler to the hopper, and a plurality of additional card pathways in the apparatus to provide for movement of the card being processed among the card input receiver, the card reader, the card writer, the card dispenser, and the card recycler.

The apparatus is particularly useful in the gaming industry. The card reader and the card writer may be adapted for reading and writing, for example, magnetic data on a magnetic stripe, bar codes, integrated circuits and the like that are located on the cards. The card input receiver and card dispenser may be part of an integral unit wherein the card enters and leaves the apparatus by a single port. The apparatus may also include a card cleaner for cleaning a card. The cleaner may be located adjacent and downstream on a card pathway from the card input receiver or elsewhere in the system.

Optionally, the card reader may accept a credit card and transmit a signal to obtain approval for use of the credit card. The apparatus may also include an input device for accepting a security code or PIN from a user. Particularly useful for credit cards, the apparatus may also include an input device for inputting a verification number and sum where the sum may be applied to credits for play on a gaming machine upon which the apparatus is mounted.

In a preferred embodiment, a cash dispenser mounted in the apparatus may also be used to dispense cash in lieu of a card. A card eraser for erasing data from a previously used card may also be included in the system. The card may then be recycled and reused by the apparatus for a future user.

A method for obtaining credits to play a gaming machine is also provided which includes the steps of providing an apparatus in the gaming machine for processing cards where the cards bear readable data, storing cards in a hopper in the apparatus, the cards in the hopper being capable of bearing machine readable data, optionally inputting a previously used card into the apparatus, the previously used card having written thereon data representing an amount of money available for playing the gaming machine or the previously used card may be a credit card, reading data written on the card by the apparatus, and playing the gaming machine. The method further includes the steps of writing new data on the previously used card or on one of the plurality of cards in the hopper where the new data represents an amount of money remaining on the card. Finally, the method includes the step of dispensing the card from the hopper or the previously used card having the new data written thereon from the apparatus for receipt by a user.

The steps that include reading and writing may include reading and writing magnetic data onto a magnetic stripe, reading and writing bar codes printed on cards, reading and writing data to or from an integrated circuit that is integral to the cards, and the like. An optional step of cleaning the previously used card prior to reading the card may be included.

The step of inputting a previously used card may include inputting a credit card. Here, the method may further include the steps of transmitting a signal to a remote location to obtain credit approval, inputting a security code or PIN to authorize use of the card, and/or inputting a verification number and sum into a keypad, where the sum is used to apply credits for play on the gaming machine.

A step of dispensing cash in lieu of the step of dispensing a card having a money value written thereon after play may be included.

A step of recycling the previously used card by adding the previously used card to the plurality of cards in the hopper may be included, here, the previously used card may be added to the top or the bottom of the pile of cards in the hopper for immediate re-use or later re-use.

Finally, the method may include the step of rejecting and ejecting defective cards at any point in the method.

In a more specific embodiment of the present invention, an apparatus for processing cards bearing machine readable data is provided which includes a housing, a hopper in the housing for storing and dispensing new and used cards capable of bearing machine readable data, a card input receiver mounted in the housing for receiving a previously used card in the apparatus and a card reader for reading data on the previously used card, mounted in the housing. The apparatus further includes a card writer for writing data onto the previously used card or a card from the hopper mounted in the housing, a card dispenser mounted in the housing for dispensing at least one of the previously used card or the card from the hopper out of the housing to a user, a card recycler for erasing a previously used card for reuse and a rotary unit for moving at least one of the previously used card or the card from the hopper among the card reader, card writer, card receiver, card dispenser, and hopper.

Preferably, the apparatus is mounted in a gaming machine. The card reader and the card writer may be adapted to read and write magnetic data onto a magnetic stripe on cards being processed, or may be adapted to read and write bar codes printed on cards being processed, or may be adapted to transfer data to or from an integrated circuit that is integral to each card being processed.

The card input receiver and card dispenser may be part of an integral unit wherein the card enters and leaves the apparatus by a single port. The apparatus may include a card cleaner for cleaning a card where the cleaner is located adjacent to and downstream on a card pathway from the card input receiver.

The card reader may accept a credit card, and may transmit a signal to obtain approval for use of the credit card. The apparatus may include an input device for accepting a security code or PIN from a user. The apparatus may include an input device for inputting a verification number and sum where the sum may be applied to credits for play on a gaming machine upon which the apparatus is mounted. A cash dispenser may be mounted in the apparatus. A card eraser for erasing data from the card and/or a card recycler may be included.

Finally, the apparatus may include a printer. Here, the rotary unit moves at least one of the previously used card and the card from the hopper among the card reader, card writer, card receiver, card dispenser, and hopper and printer.

### BRIEF DESCRIPTION OF SEVERAL VIEWS OF THE DRAWINGS

The invention will be described in conjunction with the following drawings, wherein:

FIG. 1 is a simplified view of a gaming system upon which the card reader/writer/dispenser apparatus of the present invention is mounted;

FIG. 2 is a simplified schematic view of a gaming system card reader/writer/dispenser apparatus having provision for card recycling in accordance with a first preferred embodiment of the present invention;

FIG. 3 is flowchart of a method for using a gaming card reader/writer/dispenser apparatus having provision for card recycling in accordance with FIG. 2;

FIG. 4A is a simplified schematic diagram of a card reader/writer/dispenser apparatus having provision for card recycling in accordance with FIG. 2, wherein a card rotator unit is in a position providing for movement of a card from a magnetic card reader/writer to a dispenser;

FIG. 4B is a simplified schematic diagram of the card reader/writer/dispenser apparatus of FIG. 4A, wherein the card rotator unit is in a position providing for movement of a card from a magnetic card reader/writer to a capture bin; and

FIG. 4C is a simplified schematic diagram of the card reader/writer/dispenser apparatus of FIG. 4A, wherein the card rotator unit is in a position providing for movement of a card from a magnetic card reader/writer to a thermal printer or from the dispenser to the magnetic card reader/writer/dispenser.

### DETAILED DESCRIPTION OF THE INVENTION

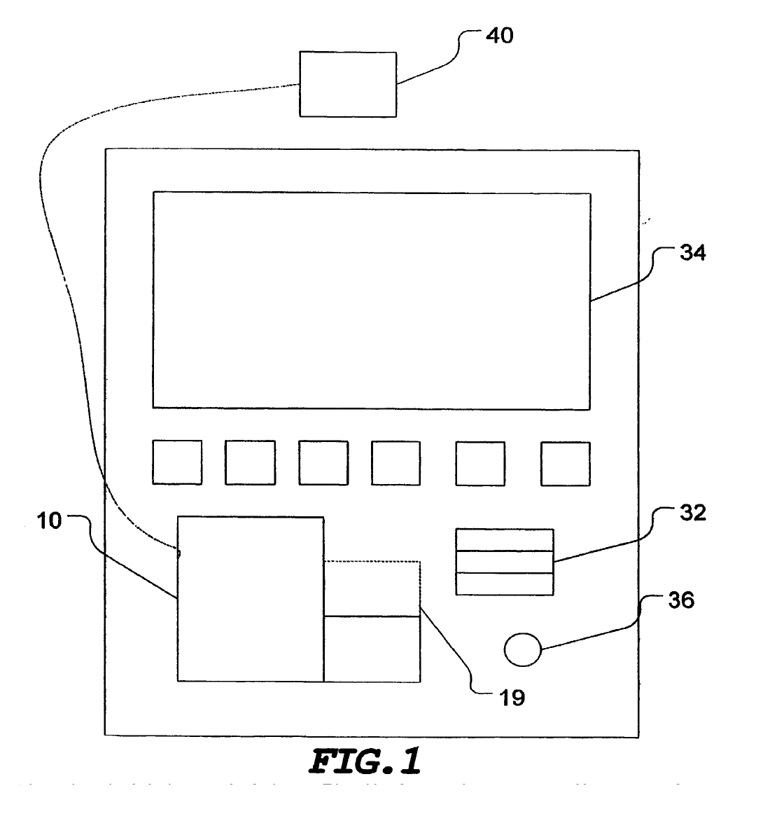

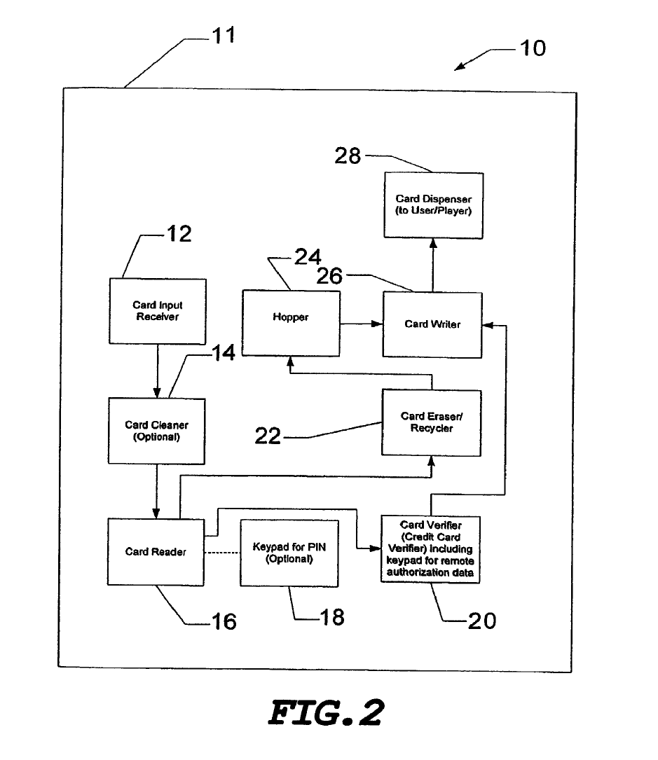

Referring now to the drawing figures wherein like part numbers refer to like elements throughout the several views, there is shown in FIG. 1 a simplified view of an electronic gaming machine 5 upon which a gaming system card reader/writer/dispenser apparatus 10 of the present invention is mounted. FIG. 2 depicts a simplified schematic view of the gaming system card reader/writer/dispenser apparatus having provision for card recycling 10 in accordance with a first preferred embodiment of the present invention. The basic components of the card reader/writer/dispenser apparatus 10 are well known individually and include a housing 11, a card input receiver 12, an optional card cleaner 14, a card reader 16, a card writer 26, a card eraser/recycler 22, a card dispenser 28, and a hopper containing cards 24. These components may each be an individual unit or they may be combined. For example, the card reader, card writer, and card eraser/recycler may be a single unit with a single read/write/erase head. Likewise, for example, the card input receiver 12 may also be the card dispenser 28 such that it both receives a card from a player and dispenses a card to the player. All of these basic elements are mounted in the housing 11.

The card input receiver 12 is adapted to receive a previously used card from a user. The card may be substantially any type of card capable of having data or indicia stored, encoded, printed or otherwise located on the card that is machine readable and writable. For example, the card may have an integrated chip (IC), a magnetic stripe, a bar code, and the like. The card reader/writer/dispenser apparatus 10 includes the hopper 24 located in the housing 11 for storing and dispensing cards. The cards must be capable of bearing machine readable data and having written thereon machine readable data.

The apparatus 10 further includes the card reader 16 for reading data on the previously used cards, mounted in the housing 11. Such a card reader 16 is commonly known. When a card is inserted into the card reader 16, it may first be cleaned in a card cleaner 14 to assist in proper reading of the card. The card cleaner 14 may be located elsewhere in the system, for example, as part of the card eraser/recycler 22. Once the card is cleaned (if applicable), the card moves to the card reader 16 which reads data that has been encoded, printed or otherwise written on the card. The card reader 16 is connected to, for the gaming system 5, upon which the apparatus 10 is attached. Any money encoded or otherwise written thereon would be available for use. The apparatus 10 may have a keypad 18 for entry of a security code or PIN that may be associated with some cards. The apparatus 10 may also have a credit card verifier 20 that allows a user to enter a dollar amount so that a credit card company can be remotely contacted (e.g., transmitted through phone lines or the internet or other known means) to verify the transaction (as is well known). Again, a keypad (either keypad 18 or a separate keypad (not shown)) may be provided as part of the card verifier 20 to allow a user to enter information, such as a dollar amount and/or a code.

The user then has access to the credits written on the card. Once the user finishes playing, if any credits remains on the gaming machine 5 he or she is playing on, the user can request either a card having the dollar amount remaining encoded on a card, the money credited to a financial account, or the user can request a cash payout. The card writer 26 then writes data on the previously used card or a on card from the hopper 24 mounted in the housing 10. A card dispenser 28 mounted in the housing 10 dispenses either the previously used card or the card from the hopper to the user.

An important feature of the present invention is the card recycler 22 for erasing a previously used card for reuse. After play, if a player desires to obtain a cash payout or if the user has no money remaining on the gaming machine or other machine he or she is using, the apparatus 10 may erase and recycle the used card for re-use by another player. Here the used card moves to the hopper 24 and will eventually be re-used. Obviously, a card pathway is required from the card recycler to the hopper. Alternatively, the used cards may be moved to a second used card hopper (not shown in FIG. 1) after recycling. Here the apparatus may provide either new cards from the new card hopper or used cards from the used card hopper to a new player. Cards from either hopper will perform satisfactorily. Additionally, card pathways are provided in the apparatus for movement of the card being processed among the card input receiver 12, the card reader 16, the card writer 26, the card dispenser 28, and the card eraser/recycler 22. These pathways are shown schematically in FIG. 1 by the arrows.

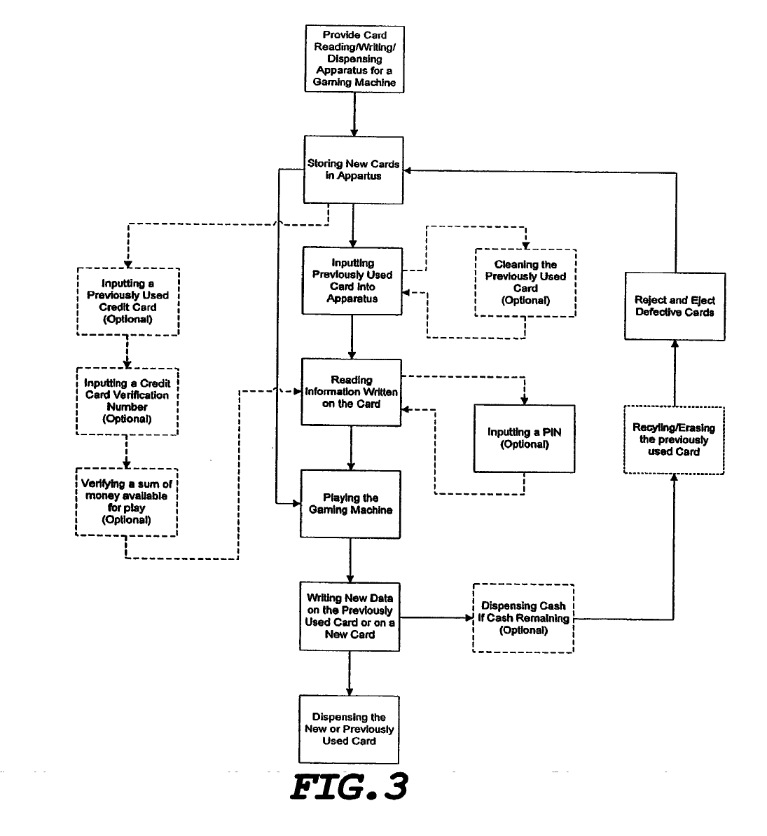

The present invention is also directed to a method for obtaining credits to play a gaming machine 5, as shown in the schematic diagram of FIG. 3. The method includes the steps of providing an apparatus 10 in the gaming machine for processing cards, the cards bearing machine readable data, storing cards in the apparatus 10, optionally inputting a previously used card into the apparatus 10, the previously used card having written thereon data representing an amount of money (credits) available for playing the gaming machine 5, and reading data written on the card. The process further includes the steps of playing the gaming machine 5 and writing new data on the previously used card or on one of the plurality of cards in the hopper 24 where the new data represents an amount of money remaining on the card. The process continues with the steps of dispensing the card from the hopper 24 or the previously used card having the new data written thereon from the apparatus for receipt by a user. Again, the steps including reading and writing include reading and writing, for example, magnetic data on a magnetic stripe on the card, reading and writing bar codes printed on cards being processed, or reading and writing data to or from an integrated circuit that is integral to each card being processed. Optionally, a step of cleaning the previously used card prior to reading the previously used card may be included in the method.

The step of inputting a previously used card may include inputting a credit card. Here, the method may further include the step of transmitting a signal to a remote location to obtain credit approval. The use of a security code or PIN to authorize use of the credit card (or other type of card) may also be used. A verification number and sum may be entered into a keypad 18 for credit verification. The sum is then used to apply credits for play on the gaming machine.

Rather than obtaining a card with an amount of money written thereon, cash may be dispensed. If so, the card is retained and may be recycled and reused by the apparatus 10. The recycled cards may be added to the cards in the hopper 24 for future dispensing. The previously used cards may be moved to the Atop@ of the pile for immediate reuse or to the Abottom@ of the pile for later reuse.

Finally, if there is a defective card found at any step in the present method, it may be rejected by the apparatus 10 and dispensed back to the user or retained in capture bin 23.

A benefit of the present apparatus 10 and method is that they allow a user (e.g., a player at a gaming machine) to play anonymously if he or she so desires. For example, a player may approach a gaming machine 5, insert cash into the machine 5 to play, and win, for example, one hundred dollars. The player could opt to collect his or her winnings in cash or could request payment in the form of a card with the amount of winnings encoded thereon. He or she could then take that card to another gaming machine and play that second machine for a period of time, for example, until there is fifty dollars on the card. The player could then cash out at the gaming machine and obtain the fifty dollars, or the player could again take his or her winnings in the form of a card. If the value on the card drops to zero, the apparatus would retain the card for recycling and re-use by another player. If the player decides to cash out and obtain cash for remaining money owed, again, the apparatus 10 would retain the card for re-use by another player.

An apparatus that includes a card reader, a card writer, and a card dispenser that has the capability to recycle and re-use a card would be particularly beneficial in the gaming industry and offers numerous advantages. One primary advantage is that such an apparatus would save money in the cost of cards. The ability to immediately recycle and re-use cards would result in directly reducing the number of cards required.

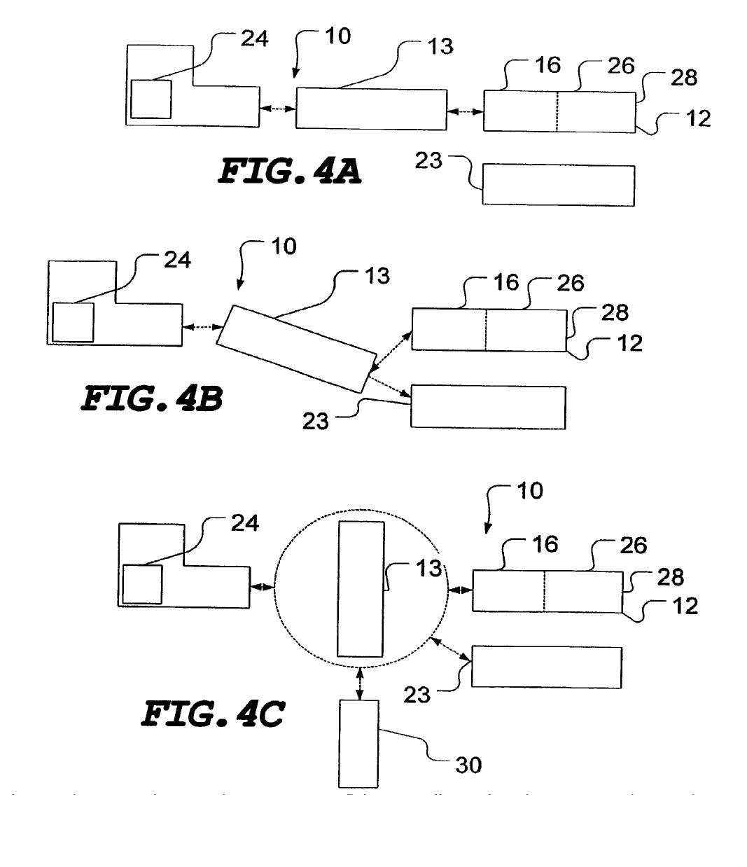

FIGS. 4A, 4B and 4C depict simplified schematic diagrams of a preferred embodiment of a card reader/writer dispenser apparatus having provision for card recycling 10 in accordance with the present invention. Here, new blank cards may be loaded in the hopper 24 of the card reader/writer/dispenser apparatus 10 either by opening a door (not shown) in the apparatus 10 in a standard manner to obtain access to its hopper 24, or by feeding individual cards into a motorized card input receiver 12. The cards are read by the card reader 16. Cards are passed into a rotator unit 13 from the card reader/writer/dispenser apparatus 10 for distribution to either the hopper 24 or a capture bin 23. The capture bin 23 may store defective cards or cards otherwise not suitable for continued use. The rotator unit 13 may also transport dispensed cards from the hopper 24 to the card reader 16 and card writer 26. Additionally, the rotator unit 13 can be used to transport cards to, for example, a thermal printer/eraser 30. Cards may enter the rotator unit 13 from either the card reader 16/card writer 26 or the hopper 24, or from other locations.

In use, as shown in FIG. 1, a player may insert cash into an electronic gaming machine 5, play the electronic gaming machine 5 and press a collect button 36 to collect his or her credits. The credits on the electronic gaming machine 5 are transferred to a site controller 40. An account is opened by the site controller 40 and a card is issued from the card reader/writer/dispenser apparatus 10 in the electronic gaming machine 5.

The card is then encoded, for example, with a number, which allows access to the specific account opened by the site controller 40 and, therefore, the funds in the account. These funds may be accessible via other devices such as another electronic gaming machine 5, a cash register or a redemption terminal (not shown).

A customer with an operational card inserts the card into the card reader/writer/dispenser apparatus 10 of the electronic gaming machine 10. The credits available in the account that are usable by a player are accessed by that card and are downloaded to the electronic gaming machine 5 on which the player is playing. When the player is finished playing the electronic gaming machine 5, if the credit balance is zero, the account is closed and the card is either stacked for reuse in the hopper 24 or placed in the capture bin 23. If the player has a positive credit balance on the electronic gaming machine 5 and a Acollect@ button 36 on the electronic gaming machine is pressed, a card is issued to the player having account data encoded or imprinted thereon so that he or she may use the funds on another electronic gaming machine 5. Alternatively, the player may redeem the funds, using the card, via a redemption terminal (not shown).

The card reader/writer/dispenser apparatus 10 may also be used in a system that conducts player tracking. Here, a player that is a member of a player tracking club inserts his or her card in the card reader/writer/dispenser apparatus 10 of an electronic gaming machine 5. He or she may be asked, via the display screen 34 (e.g., an LCD screen) to input his or her PIN. He or she will then be advised on the display screen 34 that he or she has been recognized, what his or her points level is, and if any credits remain in his or her account. The credit balance will be automatically downloaded to the electronic gaming machine 5. While the player is playing, player points will be collated and added to the players points purse when the play is finished. On pressing the collect button 36, the card is returned to the player and any points and cash will be added to the player=s account. If all of the credits on the electronic gaming machine 5 are used up, the card will be returned to the player to avoid player walk-away.

If a non-member inserts cash into the electronic gaming machine 5, he or she is asked via the display screen 34 if he or she his a member. If the player says no, the player is invited to join. If the player presses a Ayes@ button, instructions on the display screen are followed using a keypad 18 to input details. The player is then invited to play. Upon completion of play (e.g., when the player presses a collect button 36 or when there are no credits on the electronic gaming machine 5, a member card will be issued. If the player declines to join, the player is invited to carry on with play and is treated as a casual player. A redemption terminal or cashier may be used to obtain cash for credits.

Optionally, an electronic gaming machine 5 may include a Asecure@ PIN keypad 18 in place or a standard PIN keypad. The secure PIN keypad provides access for an existing player to access his or her account without the need to have a card present. The player keys in a user identification number and PIN into the keypad 18 to access his or her account. The balance of credits in the account is downloaded to the electronic gaming machine 5 and the player plays in the normal way. To return the credits to his or her account, the user identification number and PIN are re-entered.

Preferably, particularly on an electronic gaming machine 5 that has a secure PIN keypad 18 installed and the reader/writer/dispenser apparatus 10 of the present invention, the electronic gaming machine 5 has the capability of processing credit and debit card transactions. This capability operates substantially the same as an ATM transaction, which is well known. If the customer wants to collect credits from the electronic gaming machine 5 after play is ended, the collect button 36 is pressed and a card will be issued from the reader/writer/dispenser 10. If the player wishes to transfer credits back to his or her credit/debit card account, a reverse credit transaction is performed.

While the invention has been described in detail and with reference to specific embodiments thereof, it will be apparent to one skilled in the art that various changes and modifications can be made therein without departing from the spirit and scope thereof.

What is claimed is:

1. An apparatus for processing cards bearing machine readable data, comprising:
(A) a housing;
(B) a hopper in the housing for storing and dispensing new and used cards capable of bearing machine readable data;
(C) a card input receiver mounted in the housing for receiving a previously used card in the apparatus;
(D) a card reader for reading data on the previously used card, mounted in the housing;
(E) a card writer for writing data onto the previously used card or a card from the hopper, mounted in the housing;
(F) a card dispenser mounted in the housing for dispensing at least one of the previously used card or the card from the hopper out of the housing to a user;
(G) a card recycler for erasing a previously used card for reuse;
(H) a card pathway from the card recycler to the hopper; and
(I) a plurality of additional card pathways in the apparatus to provide for movement of the card being processed among the card input receiver, the card reader, the card writer, the card dispenser, and the card recycler.

2. The apparatus of claim 1 wherein the apparatus is mounted in a gaming machine.

3. The apparatus of claim 1, wherein the card reader and the card writer are adapted to read and write magnetic data onto a magnetic stripe on cards being processed.

4. The apparatus of claim 1, wherein the card reader and the card writer are adapted to read and write bar codes printed on cards being processed.

5. The apparatus of claim 1, wherein the card reader and the card writer are adapted to transfer data to or from an integrated circuit that is integral to each card being processed.

6. The apparatus of claim 1, wherein the card input receiver and card dispenser are part of an integral unit wherein the card enters and leaves the apparatus by a single port.

7. The apparatus of claim 1, including a card cleaner for cleaning a card, the cleaner located adjacent and downstream on a card pathway from the card input receiver.

8. The apparatus of claim 1, wherein the card reader accepts a credit card, and transmits a signal to obtain approval for use of the credit card.

9. The apparatus of claim 8, wherein the apparatus includes an input device for inputting a verification number and sum where the sum may be applied to credits for play on a gaming machine upon which the apparatus is mounted.

10. The apparatus of claim 1, including a cash dispenser mounted in the apparatus.

11. A method for obtaining credits to play a gaming machine comprising the steps of:
(A) providing an apparatus in the gaming machine for processing cards, the cards bearing machine readable data,
(B) storing a plurality of new and used cards in a hopper in the apparatus, the cards being capable of bearing machine readable data;
(C) optionally inputting a previously used card into the apparatus, the previously used card having written thereon data representing an amount of money available for playing the gaming machine or the previously used card being a credit card;
(D) reading data written on the card by the apparatus;
(E) playing the gaming machine;
(F) writing new data on the previously used card or on one of the plurality of cards from the hopper, the new data representing an amount of money remaining on the cards; and
(G) dispensing the card from the hopper or the previously used card having the new data written thereon from the apparatus for receipt by a user.

12. The method of claim 11, wherein the steps including reading and writing read and write magnetic data onto a magnetic stripe on card being processed.

13. The method of claim 11, wherein the steps including reading and writing read and write bar codes printed on cards being processed.

14. The method of claim 11, wherein the steps including reading and writing transfer data to or from an integrated circuit that is integral to each card being processed.

15. The method of claim 11, including the step of cleaning the previously used card prior to reading the previously used card.

16. The method of claim 11, wherein the step of inputting a previously used card includes inputting a credit card and wherein the method further includes the step of transmitting a signal to a remote location to obtain credit approval.

17. The method of claim 16, including the step of inputting a security code or PIN to authorize use of the card.

18. The method of claim 16, including the step of dispensing cash in lieu of the step of dispensing the card having a money value written thereon.

19. The method of claim 16, including the step of recycling the previously used card by adding the previously used card to the plurality of cards in the hopper.

20. An apparatus for processing cards bearing machine readable data, comprising:
(A) a housing;
(B) a hopper in the housing for storing and dispensing new and used cards capable of bearing machine readable data;
(C) a card input receiver mounted in the housing for receiving a previously used card in the apparatus;
(D) a card reader for reading data on the previously used card, mounted in the housing;
(E) a card writer for writing data onto the previously used card or a card from the hopper, mounted in the housing;
(F) a card dispenser mounted in the housing for dispensing at least one of the previously used card or the card from the hopper out of the housing to a user;
(G) a card recycler for erasing a previously used card for reuse;
(H) a rotary unit for moving at least one of the previously used card or the card from the hopper among the card reader, card writer, card receiver, card dispenser, and hopper.

21. The apparatus of claim 20 wherein the apparatus is mounted in a gaming machine.

22. The apparatus of claim 20, wherein the card reader and the card writer are adapted to read and write magnetic data onto a magnetic stripe on cards being processed.

23. The apparatus of claim 20, wherein the card reader and the card writer are adapted to read and write bar codes printed on cards being processed.

24. The apparatus of claim 20, wherein the card reader and the card writer are adapted to transfer data to or from an integrated circuit that is integral to each card being processed.

25. The apparatus of claim 20, wherein the card input receiver and card dispenser are part of an integral unit wherein the card enters and leaves the apparatus by a single port.

26. The apparatus of claim 20, including a card cleaner for cleaning a card, the cleaner located adjacent and downstream on a card pathway from the card input receiver.

27. The apparatus of claim 20, wherein the card reader accepts a credit card, and transmits a signal to obtain approval for use of the credit card.

28. The apparatus of claim 20, including a cash dispenser mounted in the apparatus.

29. The apparatus of claim 20, including a card eraser for erasing data from the card.

30. The apparatus of claim 20, wherein the apparatus includes a printer and wherein the rotary unit moves at least one of the previously used card and the card from the hopper among the card reader, card writer, card receiver, card dispenser, and hopper and printer.
